(19) United States
(12) Patent Application Publication
(10) Pub. No.: US 2010/0059663 A1
(43) Pub. Date: Mar. 11, 2010

(54) MICRO-STRUCTURED SPECTRAL FILTER AND IMAGE SENSOR

(75) Inventor: Yohan Desieres, Grenoble (FR)

Correspondence Address: PEARNE & GORDON LLP, 1801 EAST 9TH STREET, SUITE 1200, CLEVELAND, OH, 44114-3108, US

(73) Assignee: COMMISSARIAT A L'ENERGIE ATOMIQUE, Paris (FR)

(21) Appl. No.: 12/297,255

(22) PCT Filed: Apr. 18, 2007
(86) PCT No.: PCT/EP2007/053800

§ 371 Date: Nov. 16, 2009

(30) Foreign Application Priority Data
Apr. 19, 2006 (FR) 06 51368

(51) Int. Cl. G02B 5/22; G01J 3/51; B05D 5/06; B29D 11/00

(52) U.S. Cl. 250/226; 359/885; 427/162; 216/24

(57) ABSTRACT

The invention relates to a spectral filter (100) comprising at least one metal layer (101) structured by a grating of traversing slots (102a to 102e, 103a to 103h). The grating consists of at least two subgratings of traversing slots (102a to 102e, 103a to 103h) intercepting one another perpendicularly.

### TECHNICAL FIELD AND PRIOR ART

The invention concerns the field of filtering techniques and, in particular, that of spectral filters used in image sensors.

Image sensors, which are notably found in mobile telephones and digital cameras, principally consist of a matrix of photodetectors and focusing optics. These optics enable the image of an object to be formed on the matrix of photodetectors. To obtain images in colours, it is known to align a grating 20 of coloured filters on the pixels of the sensor. The matrixing of this grating 20 is carried out according to a scheme known as “BAYER”, as is represented in FIG. 1A, which matrixes a red filter 2, two green filters 4, 6, and a blue filter 8. Each of the photodetectors arranged under these filters constitutes a sub-pixel. The set of these four sub-pixels constitutes a pixel 10 of the matrix of photodetectors. The colour of the image is digitally reconstructed from the “mono colour” signals received by the pixels of the matrix of photodetectors. These filters are normally positioned several micrometres above photodetectors 12, electrical interconnections 14 and dielectric passivation layers 16, as is represented in FIG. 1B.

In the field of mass-produced image sensors, the sensor is placed at the focal spot of a lens of wide aperture: the average incidence angle of the light beams on the sensor can vary from −25° to +25° between two spots of the sensor and the angular aperture on each pixel of the sensor is typically around +/−10°. Each filter is illuminated under multiple incidences. To achieve the filtering of colours, it is important that the properties of the filters (transmission wavelength, transmission level, spectral width) are constant whatever the incidence angle. Filters whose properties are independent of the incidence angle must be used.

To do this, it is known to use a grating of parallel slots to filter the light: this filter is, by virtue of its geometric characteristics, adapted to a range of wavelengths. Indeed, the document US 2003/0103150 discloses a uni-dimensional grating of slots opening into a metal layer to perform the function of filtering of colours. With this geometry, calculations show that it is the slots that also assure the transmission of the light beams filtered through the metal layer. They also show that the filtering is more selective when the slots have a width less than the wavelengths of visible light.

However, the photometric yield of these filters is very low because only one polarisation of the light is filtered and transmitted, which is a major drawback for the targeted application field.

Another limitation is linked to the existence of electromagnetic modes at the surface of the metal layer forming the grating of slots, known as surface plasmons. These electromagnetic modes may be excited during the diffraction of the incident light on the slots of the metal layer. This excitation, selective in wavelength and in angle, degrades the band pass filter function performed by the slots.

### DESCRIPTION OF THE INVENTION

One aim of the present invention is to propose a device assuring a wavelength filtering, the transmission properties of which are constant whatever the incidence angle of the light beams, and enabling a high photometric yield to be obtained.

To achieve this aim, the present invention proposes a spectral filter comprising at least one metal layer structured by a grating of traversing slots, wherein the grating consists of at least two first subgratings of traversing slots intercepting one another perpendicularly.

Thus, with such a spectral filter, it is possible to assure the transmission and the filtering both of the transverse electric TE polarised modes and the transverse magnetic TM polarised modes of the light beams received, enabling a good photometric yield of the filter to be obtained, particularly in the incidence conditions of CMOS type image sensors.

In addition, the invention enables the wavelength transmitted by the filter to be adjusted by means of its geometric parameters and not chemical parameters linked to the filter.

The spectral filter may further comprise at least one third subgrating of traversing slots intercepting the slots of the two first subgratings.

The slots of the third subgrating may intercept the slots of the two first subgratings at an angle equal to around 45 degrees.

The spectral filter may also further comprise at least one fourth subgrating of traversing slots intercepting the slots of the two first subgratings and the slots of the third subgrating.

The slots of the fourth subgrating may perpendicularly intercept the slots of the third subgrating. Thus, when the slots of the third subgrating intercept the slots of the two first subgratings at an angle equal to around 45 degrees, the slots of the fourth subgrating also intercept the slots of the two first subgratings at an angle equal to around 45 degrees, forming four subgratings of slots offset from each other by 45 degrees.

The slots of one or each of the subgratings may be regularly spaced apart and/or each comprise an identical width.

Each subgrating may be formed by the repetition of a periodic pattern, said periodic pattern comprising one of the slots of the subgrating and a part of the metal layer separating two adjacent slots of the subgrating.

The width of the periodic pattern of one or each of the subgratings may be less than around 350 nm.

The spectral filter may also further comprise at least one first dielectric layer arranged above the structured metal layer and/or at least one second dielectric layer arranged below the structured metal layer.

The thickness of the first and/or the second dielectric layer may be between around 50 nanometres (nm) and several hundreds of nm.

The present invention also concerns an image sensor comprising at least one first and one second spectral filter, subject of the present invention, arranged in a same horizontal plane, and at least two photodetectors arranged underneath the spectral filters.

The thickness of the metal layer of the first spectral filter may be different or identical to the thickness of the metal layer of the second spectral filter.

The width of the periodic pattern and/or the width of the slots of the two spectral filters may be identical or different.

The image sensor may further comprise a protective layer covering the spectral filters.

The image sensor may further comprise a third and a fourth spectral filter, the four spectral filters forming a Bayer filter, and at least two other photodetectors each arranged underneath one of the third and fourth spectral filters, the Bayer filter and the four photodetectors forming a pixel of the image sensor.

The image sensor may also comprise a support layer arranged between the photodetectors and the spectral filters.

The present invention also concerns a method of producing a spectral filter, comprising the following steps:
forming a grating of slots in a dielectric layer, wherein the grating consists of at least two subgratings of slots intercepting one another perpendicularly,
depositing a metal layer in the grating of slots formed in the dielectric layer,
planarising the metal layer.

The invention also covers another method of producing a spectral filter, comprising the steps of:
depositing a metal layer on a dielectric layer,
impressing the metal layer forming, in the metal layer, a grating of slots, wherein the grating of slots consists of at least two subgratings of slots intercepting one another perpendicularly,
etching the metal layer at the level of the slots to make them traversing,
depositing a dielectric layer on the metal layer,
planarising said dielectric layer.

After the planarisation step, the method may comprise a step of transferring the spectral filter onto another layer of dielectric through the intermediary of the dielectric layer of the spectral filter.

Finally, the present invention also concerns a method of producing an image sensor, comprising, before the step of forming at least one spectral filter, subject of the present invention, a step of depositing a support layer on at least one photodetector, wherein the spectral filter is formed on or transferred onto the support layer.

### BRIEF DESCRIPTION OF DRAWINGS

The present invention will be better understood on reading the description of embodiments given solely by way of indication and in no way limiting and by referring to the appended figures, in which:

FIGS. 1A and 1B represent a grating of coloured filters arranged on a matrix of photodetectors according to the prior art,

FIG. 2A represents a spectral filter, subject of the present invention, according to a first embodiment,

FIG. 2B represents the metal layer of a spectral filter, subject of the present invention, according to an alternative of the first embodiment,

FIG. 3 represents transmission curves of a spectral filter, subject of the present invention, as a function of the incidence angle of the light beams,

FIG. 4 represents transmission curves of a spectral filter, subject of the present invention, as a function of the thickness of the metal layer of the filter,

FIG. 5 represents an embodiment of an image sensor, also subject of the present invention,

FIGS. 6A to 6F represent the steps of a method of producing a spectral filter and an image sensor comprising this filter, subject of the present invention, according to a first embodiment,

FIGS. 7A and 7B represent the steps of a method of producing a spectral filter and an image sensor comprising this filter, subject of the present invention, according to a second embodiment,

FIGS. 8A to 8D represent the steps of a method of producing a spectral filter and an image sensor comprising this filter, subject of the present invention, according to a third embodiment,

FIGS. 9A to 9B represent the steps of a method of producing a spectral filter and an image sensor comprising this filter, subject of the present invention, according to an alternative of the three embodiments.

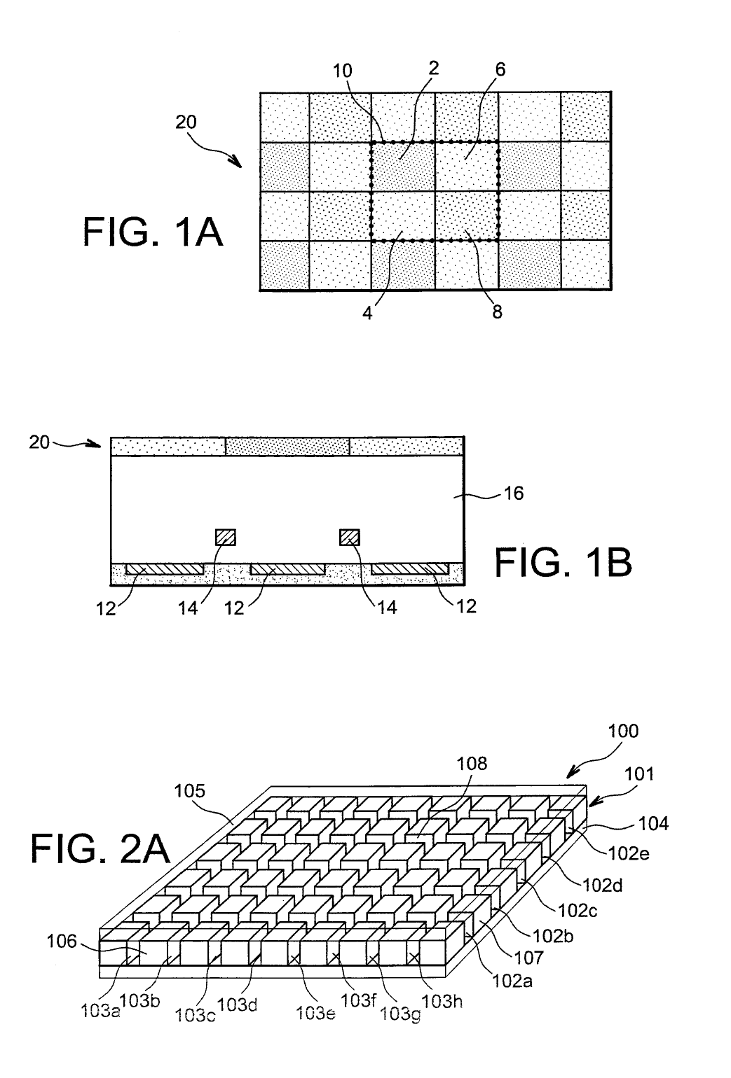

Identical, similar or equivalent parts of the different figures described hereafter bear the same number references so as to make it easier to go from one figure to the next.

In order to make the figures more legible, the different parts represented in the figures are not necessarily to a uniform scale.

### DETAILED DESCRIPTION OF SPECIFIC EMBODIMENTS

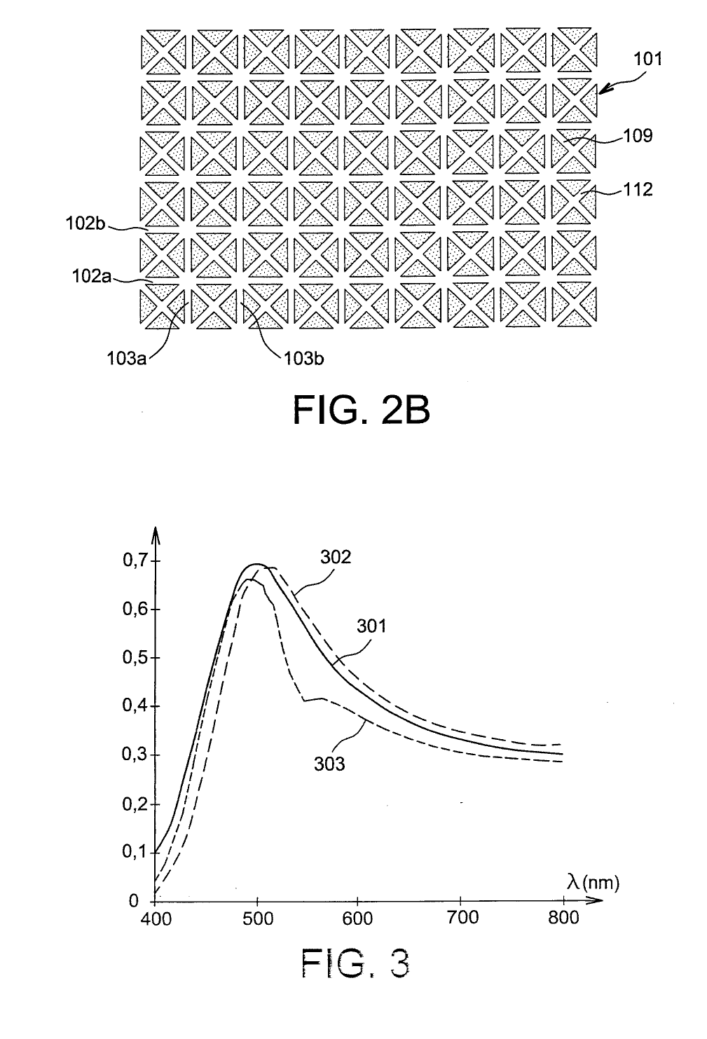

Reference will firstly be made to FIG. 2A, which represents a spectral filter 100, subject of the present invention, according to a first embodiment.

This spectral filter 100 comprises a structured metal layer 101. This structure is formed of slots 102a to 102e forming a first subgrating, and slots 103a to 103h forming a second subgrating. These slots 102a to 102e and 103a to 103h are traversing, in other words they are formed over the whole thickness of the metal layer 101. The slots 102a to 102e of the first subgrating perpendicularly intercept the slots 103a to 103h of the second subgrating.

These two subgratings perpendicular to each other enable the filtering and the transmission to be assured, both of the transverse electric TE polarised modes and the transverse magnetic TM polarised modes, these two modes being perpendicular to each other. One of the two subgratings therefore has the function of assuring the filtering and the transmission of the TM polarised light, for example the slots 103a to 103h, the slots 102a to 102e of the other subgrating assuring the filtering and the transmission of the TE polarised light.

In order to obtain high transmissions of the filtered light beams, the metal layer 101 is formed from metals the least absorbent possible in the range of transmitted wavelengths. For visible wavelengths, the metal may be for example aluminium, and/or silver and/or gold. It is also possible to use other metals, for example for wavelengths longer than those of the visible domain.

The metal layer 101 may also be formed according to an alternative represented in FIG. 2B. In addition to the two subgratings of slots 102a, 102b, . . . and 103a, 103b, . . . formed in the layer 101, two other subgratings of traversing slots 109 and 112 are formed in the metal layer 101. In the example of FIG. 2B, the slots of these two additional subgratings 109 and 112 are perpendicular to each other, intercepting the slots 102a, 102b, . . . and 103a, 103b, . . . of the two first subgratings according to an angle equal to around 45°. Four subgratings of slots 102a to 102e, 103a to 103h, 109 and 112 are then obtained, offset to each other by an angle equal to around 45°. In this way, the transmissions of the oblique incidence TE polarised light and the TM polarised light are made even more symmetric.

Each of the subgratings of FIG. 2A or FIG. 2B may be envisaged as being formed by a periodic pattern repeated several times. Thus, in each subgrating, all of the slots have an identical width and are regularly spaced apart. In the example of FIG. 2A, for the subgrating of slots 102a to 102e, the periodic pattern may for example comprise the slot 102a and a part 107 of the metal layer 101 separating the adjacent slots 102a and 102b. The subgrating is then formed by repeating this periodic pattern six times. For the subgrating of slots 103a to 103h, the periodic pattern comprises for example the slot 103a and a part 106 of the metal layer 101 separating the two adjacent slots 103a and 103b. The distance between two periodic patterns, in other words the width of a periodic pattern, is known as the pitch or period of the subgrating. In order to obtain a good response of the filter 100, little dependent on the angle of the incident light, the period of one or each of the subgratings may for example be less than 350 nm. Thus, with such a period, the resonant excitation of surface plasmons on the metal layer 101 is avoided and a good angular stability of the filter 100 is guaranteed. Generally speaking, the width of each of the slots of one or each of the subgratings is preferably between around 10% and 50% of the period of this or these subgratings.

The spectral filter 100 of FIG. 2A also comprises layers of dielectrics 104 and 105, for example thin films, arranged respectively below and above the metal layer 101. The space created by the slots 102a to 102e and 103a to 103h in the metal layer 101 is also filled with a dielectric material 108, for example similar to that of the dielectric layers 104 and 105. This dielectric material 108 is transparent to the wavelengths that are intended to be transmitted by the spectral filter 100. The refractive index of the dielectric material 108 may preferably be less than 1.6, thereby contributing to guaranteeing the angular stability of the filter 100, by avoiding the resonant excitation of surface plasmons on the metal layer 101. The dielectric material may for example be based on silicon oxide, and/or SiOC, and/or nanoporous SiOC, and/or nanoporous silica, and/or polymers. Generally speaking, the thickness of the first and/or the second dielectric layer 104 and 105 is between around 50 nm and several hundreds of nm. In FIG. 2A, the dielectric layers 104 and 105 have a thickness of around 100 nm. These dielectric layers 104 and 105 may also have structurings, for example to reduce their average index. These structurings may be similar or not to those of the metal layer 101, in other words to the slots formed in the metal layer 101. These structurings formed in the dielectric layers 104 and 105 may open out, in other words they are formed over the whole thickness of the dielectric layer, or not. These structurings may also be for example slots in which the width and/or the spacing differ compared to the slots formed in the metal layer 101. Finally, these structurings of the dielectric layers 104 and 105 may be different from one photodetector to the next.

FIG. 3 represents simulated transmission curves of a spectral filter similar to that represented in FIG. 2A. The transmission coefficient is here expressed as a function of the transmitted wavelength, expressed in nanometres. Here, the metal layer of the spectral filter is formed based on aluminium and has a thickness of around 150 nm. As in FIG. 2A, this metal layer comprises two subgratings of slots that perpendicularly intercept one other. The width of the slots is here around 85 nm, the period of the two subgratings being around 300 nm. Curve 301 represents the TE and TM transmissions when the light beams arrive on the filter with a zero incidence angle in relation to the plane of the metal layer. In this case, the TE and TM transmissions are identical. The values measured here differ little from those obtained when the metal layer only comprises a single subgrating of slots all oriented in the same direction, as described in the prior art. Indeed, the photons are mainly transmitted by the favourably oriented slots before being reflected by the unfavourably oriented slots. But for a non-polarised beam, this structure enables a net gain in transmission compared to the devices of the prior art. Curve 302 represents the TM transmission, and curve 303 the TE transmission, when the incidence angle of the light beams is around 15°. It may be seen that the angular behaviour of the filter is very stable because the TE and TM transmission values differ very little from the calculated transmission at zero incidence.

The thickness of the metal layer of a filter also has an influence on the transmission assured by the filter. Generally speaking, this thickness is between around 50 nm and several hundreds of nm. The thickness is chosen as a function of the desired transmitted wavelength, the dielectric used in the slots of the metal layer, and the desired selectivity of the filter.

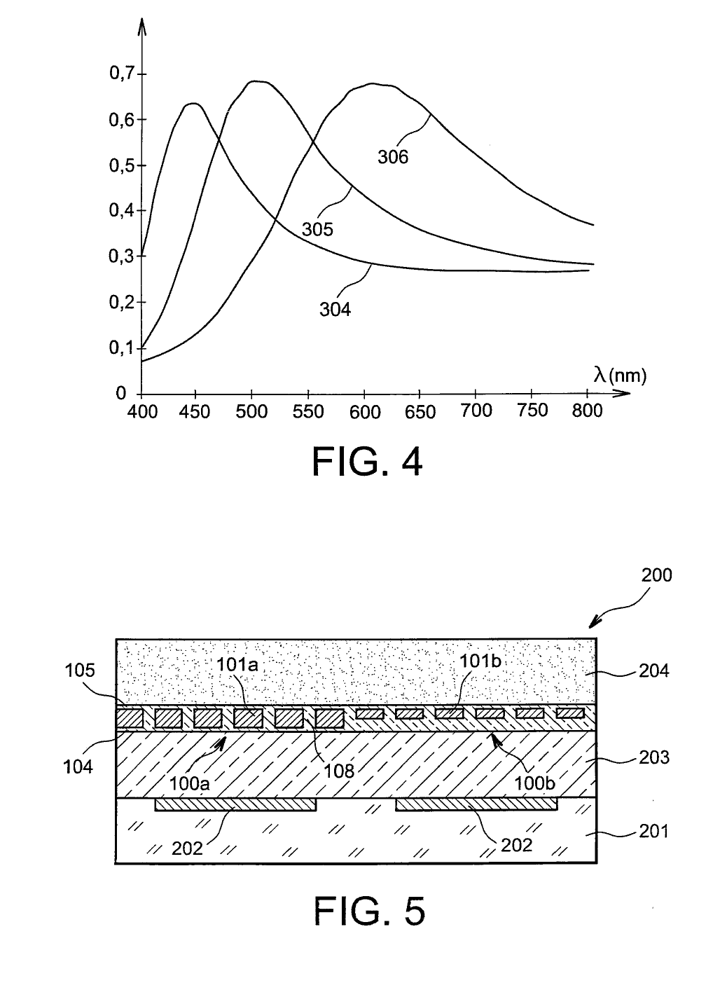

FIG. 4 represents the transmission assured by a spectral filter, similar to that represented in FIG. 2A, as a function of the thickness of the metal layer of the filter. The width of the slots is around 85 nm and the period of the subgratings is around 300 nm. The spectral filter is here surrounded with air. The value of the coefficient of transmission is expressed as a function of the transmitted wavelength, in nanometres. Curve 304 correspond to a thickness of around 130 nm, curve 305 to a thickness of around 160 nm, and curve 306 to a thickness of around 210 nm. It may be seen in these curves that the increase in the thickness of the metal layer leads to a reduction in the selectivity of the filter, but also a shift of the maximum transmission towards longer wavelengths. It is therefore possible to form N filters of N different colours by juxtaposing N layers of metal of N different heights, structured by the same grating of slots.

The filtering and the transmission assured by the spectral filter, subject of the present invention, therefore mainly depend on two factors: the dimensions of the grating of slots (width of the slots and period of the grating) and the height of the metal layer of the filter.

FIG. 5 represents an embodiment of an image sensor 200, subject of the present invention. In this figure, only two sub-pixels, in other words two photodetectors 202 and two spectral filters 100a and 100b, are represented. The image sensor 200 comprises in reality several thousands or several millions of pixels. The photodetectors 202 are formed on a substrate 201, for example in silicon, which can integrate reading circuits and digital processings.

The filters 100a and 100b each comprise a metal layer, respectively 101a and 101b. As in the example of FIG. 2A, the metal layers 101a and 101b comprise a grating of traversing slots consisting of two subgratings of traversing slots intercepting one another perpendicularly. The dimensions of these slots may for example be similar to those of the filter 100 of FIG. 2A. The filters 100a and 100b are for example arranged above a pixel comprising 4 sub-pixels configured according to a BAYER scheme, wherein the filter 100a is for example intended to filter and transmit the colour green and the filter 100b the colour blue. For this, layers 101a and 101b each have a different thickness, enabling only the desired wavelength to be filtered. As in the example of FIG. 2A, the metal layers 101a and 101b are arranged between two thin dielectric films 104 and 105, for example similar to the layers 104 and 105 of FIG. 2A, and the slots formed in the metal layers 101a and 101b are filled with a dielectric material 108. The metal layers 101a and 101b are for example formed from a unique metal layer etched as a function of the desired height of metal, in other words the wavelength to filter and transmit. The metal layers 101a and 101b form, with the two dielectric layers 104, 105, the filtering layer of the sensor 200.

The spectral filters 100a, 100b are separated from the photodetectors 202 by a support layer 203, for example based on a dielectric such as silicon nitride or silicon oxide, serving as mechanical support to the spectral filters 100a, 100b. This support layer 203 may also comprises focusing elements, not represented in this figure, serving to concentrate the incident beams on the photodetectors 202. This layer 203 may also comprise electric contacts linked to the photodetectors 202 in order to collect the signal obtained, as well as to assure the insulation and the passivation of the photodetectors 202. This support layer 203 is here transparent to the wavelengths that the sensor 200 detects.

The filters 100a and 100b are covered with a protective layer 204, for example based on polymer materials, which may integrate as function the chemical and mechanical protection of the spectral filters 100a, 100b, as well as the concentration of the light beams on the photodetectors 202. This protective layer 204 is here transparent to the wavelengths that the sensor 200 detects.

In an alternative, the metal layers 101a and 101b of the filters 100a and 100b have an equal height. In this case, so that each assures a transmission at a different wavelength (respectively for example of the colours green and blue), the dimensions of the slots of the metal layer 101a are different from the dimensions of the slots of the other metal layer 101b. These dimensions may be the width of the slots and/or the grating period.

The image sensor 200 also comprises a third 100c and a fourth 100d spectral filter, not represented in FIG. 5, forming with the two other spectral filters 100a, 100b, a Bayer filter, and at least two other photodetectors 202 each arranged under one of the third 100c and fourth 100d spectral filters. Thus, the four photodetectors 202 form a pixel of the image sensor 200, the light filtering being assured by the Bayer filter 100a, 100b, 100c, 100d.

The formation of a matrix of filters of different colours may therefore be envisaged in two different manners:
by the matrixing of filters in which the thickness of the metal layer is variable from one sub-pixel to the next. The period and the width of the slots of the gratings is then the same for all the filters of the matrix,
by the matrixing of filters in which the thicknesses of the metal layers are the same, but in which the sizes of the slots and periods differ from one filter to the next.

In both cases, the filters of the matrix may be connected to each other.

Several methods of forming a spectral filter, also subject of the present invention, will now be described. For each of these methods, the formation of an image sensor comprising four spectral filters (one blue, one red and two green), arranged according to a BAYER scheme, of a pixel will now be described.

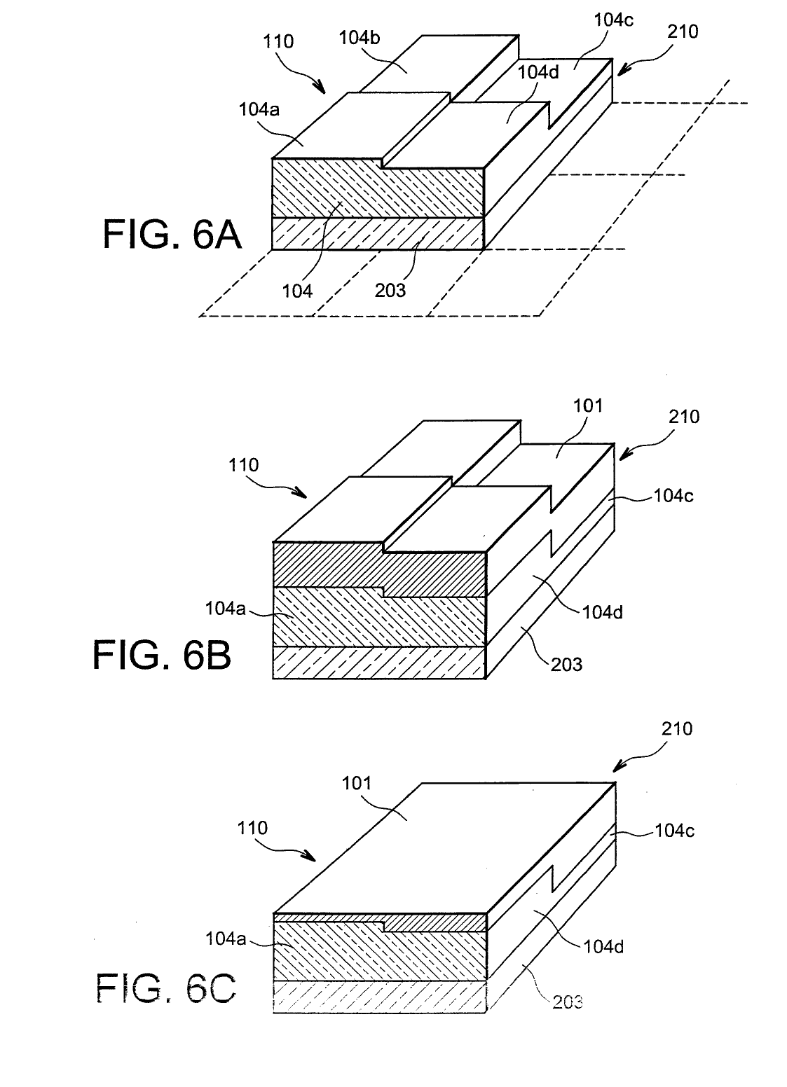

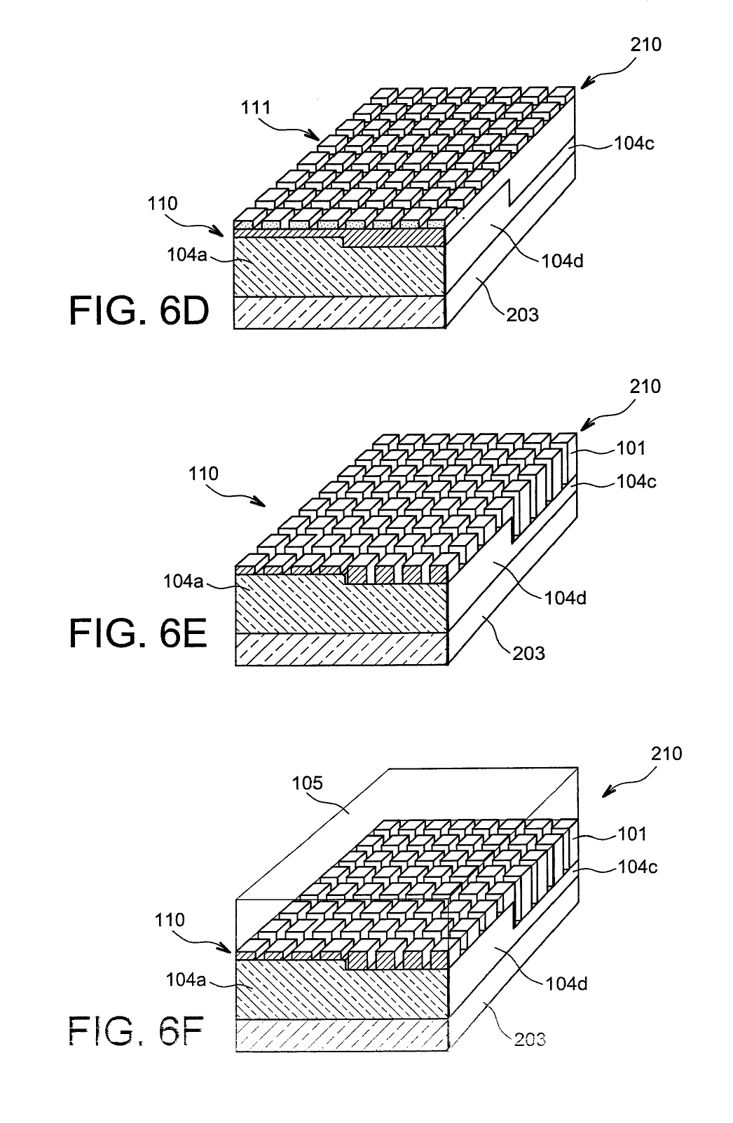

A first example is described in relation to FIGS. 6A to 6F representing the different steps of a method of producing a spectral filter 110 and an image sensor 210 comprising the spectral filter 110. In these figures, the image sensor 210 comprises four spectral filters for which only the formation of the filter 110 will be detailed.

The deposition of a dielectric layer 104 on a support layer 203 is firstly carried out, for example similar to the support layer 203 represented in FIG. 5, as is represented in FIG. 6A. The index of the material used for forming the dielectric layer 104 is here less than 1.6. This dielectric layer 104 comprises height variations as a function of the filter that is going to be formed. Thus, the dielectric layer 104 forms four pads: a first pad 104a intended to form a filter for a blue sub-pixel, a second and third pads 104b, 104d, each intended for a filter of a green sub-pixel, and a fourth pad 104c for a filter of a red sub-pixel. Each pad has for example the length of its sides between around 0.5 micrometre and several tens of micrometres and a height between around 50 nm and 200 nm. The height variation between two pads is in general between 0 nm and 100 nm. These pads may be formed for example by photo-litho etching or by nano-impression. This step therefore serves to define and align the red, green and blue filtering zones.

A metal layer 101 is then deposited on the dielectric pads 104a to 104d, as is represented in FIG. 6B. For the formation of visible light filters, the metal used is for example aluminium. This deposition is for example carried out by cathodic sputtering.

FIG. 6C represents a step of planarisation of the metal layer 101. Chemical mechanical polishing techniques may be used for this planarisation. The remaining metal layer 101 has a thickness between around 50 nm and 200 nm.

The deposition of an etching mask 111 is then carried out on the metal layer 101, as is represented in FIG. 6D. This etching mask 111 is structured by a grating of traversing slots comprising two subgratings of traversing slots intercepting one another perpendicularly. The period of the subgrating of slots is in general between around 100 nm and 400 nm, and the width of the slots between 30 nm and 150 nm. This mask 111 may for example be based on dielectric polymer. Optical or electronic exposure techniques in a solid layer of photosensitive polymer may be used for the formation of the etching mask 111. For a low cost mass production, nano-impression or even holographic exposure techniques will advantageously be used.

In FIG. 6E, an etching, such as an anisotropic etching, is then carried out on the metal layer 101 using the structured polymer layer as etching mask 111. The pattern of the perpendicular slots is therefore reproduced over the whole thickness of the metal layer 101 so as to form traversing slots.

Finally, a dielectric layer 105 for example of index less than 1.6 and of several hundreds of nm thickness is deposited on the metal layer 101, as represented in FIG. 6F. This layer 105 enables the space between the metal patterns to be filled by the dielectric material and to form the upper dielectric layer of the filter. A step of planarisation by chemical mechanical polishing is carried out if other elements (particularly optical) are added to this dielectric layer 105.

The filter 110 is formed on a photodetector 202 forming a sub-pixel of the image sensor 210. Thus, the image sensor 210 comprises a Bayer filter formed from four spectral filters, including the filter 110. A photodetector 202, not represented, is present under each of the filters, thereby forming a pixel of the image sensor 210.

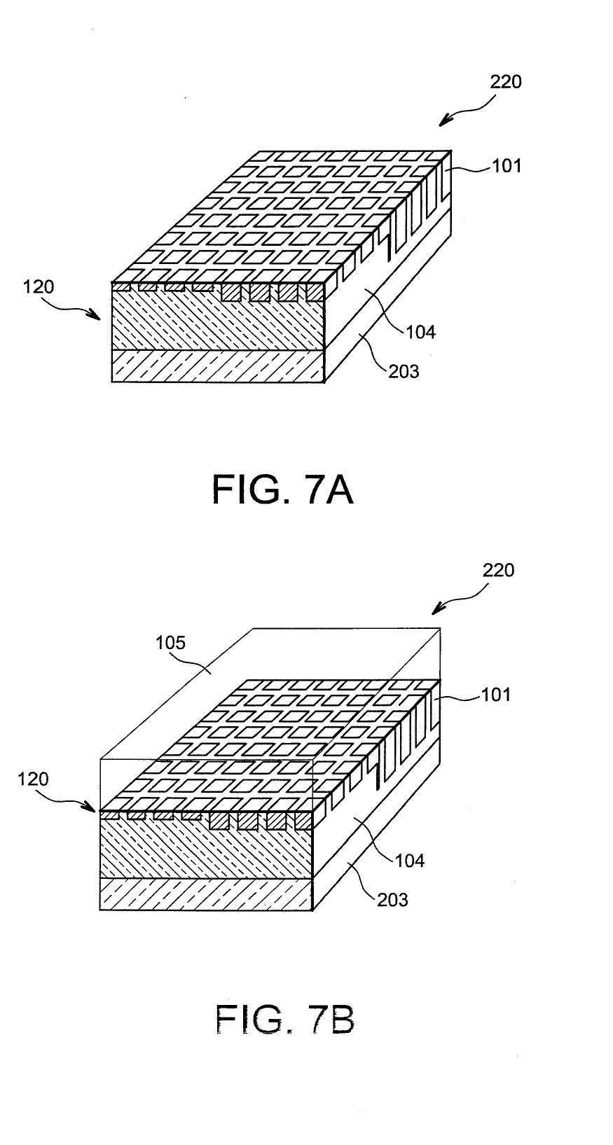

A method of producing spectral filters and an image sensor according to a second embodiment will now be described in relation to FIGS. 7A and 7B.

The impression of a structured dielectric layer 104 of index less than 1.6 is firstly carried out. This dielectric layer 104 is arranged on the support layer 203. This impression step uses nano-impression techniques to simultaneously define the first dielectric layer arranged underneath the metal layer of the filter, and the grating of perpendicular slots. The reverse pattern is here formed because the impression forms hollows intended to receive the metal to form the structured metal layer.

A metal layer 101 is then deposited on the structured dielectric layer 104 in order to fill the hollows formed in the structure of the dielectric layer 104. A cathodic sputtering technique may for example be used.

A planarisation by chemical mechanical polishing of the metal layer 101 is then carried out, up to the appearance of the buried dielectric pads of the dielectric layer 104, as is represented in FIG. 7A.

Finally, a dielectric layer 105 of index less than 1.6, of a thickness between around 100 nm and 500 nm, is deposited for example by PVD (physical vapour deposition) on the pads of the dielectric layer 104 and the metal layer 101.

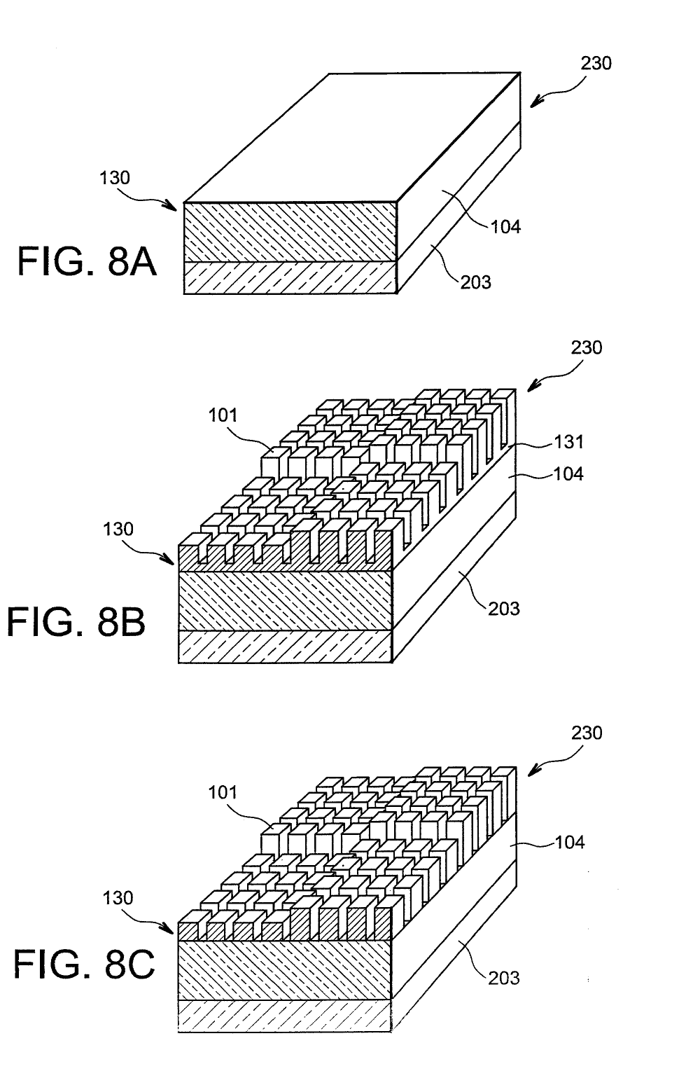

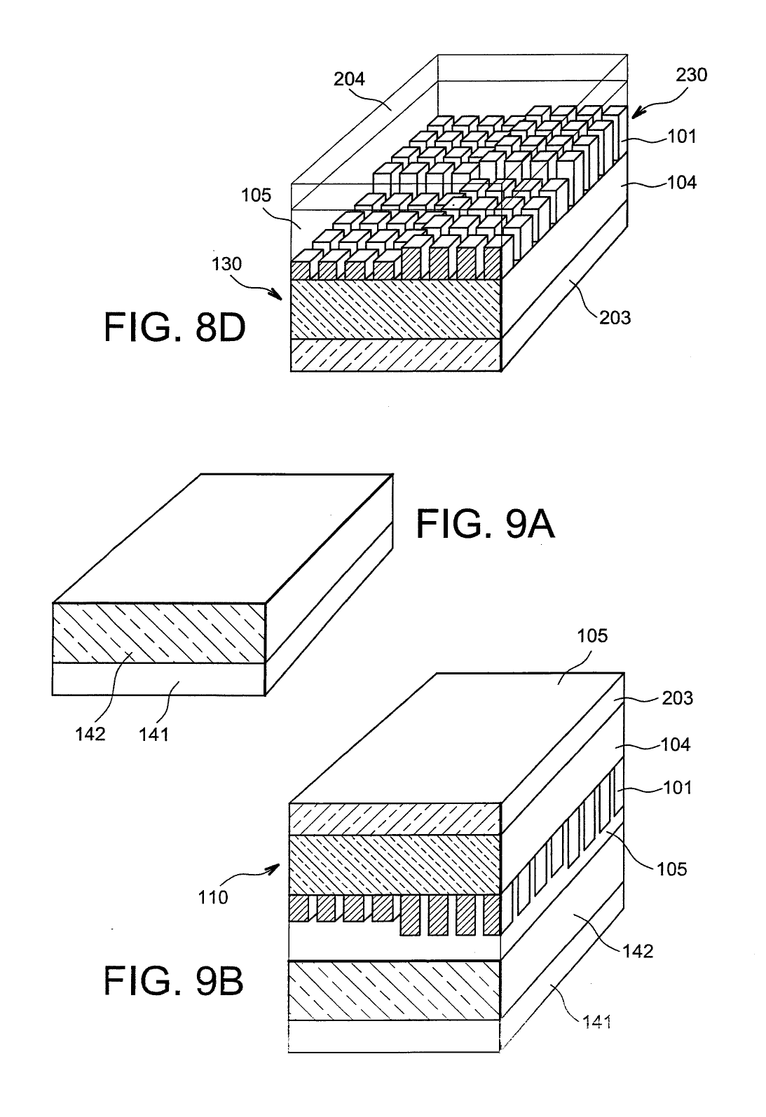

FIGS. 8A to 8D represent a third embodiment of a method of producing spectral filters according to the invention and image sensors, also according to the invention.

A dielectric layer 104, for example of index less than 1.6, is deposited on a support layer 203, as represented in FIG. 8A. This deposition may for example be carried out by PVD deposition.

In FIG. 8B, a hot nano-impression of metal pads is carried out in a metal layer 101 deposited on the dielectric layer 104. These pads comprise a grating of slots perpendicular to one another. Each of the pads formed forms the metal layer of a spectral filter. At this step, the slots are not made traversing and a sub-metal layer 131 remains formed underneath the slots. Different heights of pads are formed in order to obtain filters of different colours. It is also possible to form pads of similar height, but in which the grating of slots comprises different widths of slots and/or periods as a function of the desired filtering.

A step of etching of the metal layer 101 etches the sub-metal layer 131, thereby forming the traversing slots, as is represented in FIG. 8C.

Finally, in FIG. 8D, a dielectric layer 105, for example inorganic and of index less than 1.6, is deposited by PVD technique on the metal layer 101, thereby filling the slots with a dielectric material and forming the upper dielectric layer. This upper protective layer could also be based on a planarising polymer, also of index less than 1.6. In this case, the deposition could be carried out by spin coating (or deposition by centrifugation).

Finally, a protective layer 204 is deposited on the dielectric layer 105, thereby covering the spectral filters formed.

In an alternative of these three embodiments, it is possible to form the spectral filters 110, 120, 130 on a temporary and/or transparent support layer 203, for example based on silicon or glass, then assembled on the photodetectors by aligned molecular bonding techniques.

In this case, as is represented in FIG. 9A, a deposition of a dielectric layer 142, for example of index less than 1.6, is carried out on a support layer 141.

Then, the spectral filter 110, 120 or 130 formed previously is transferred onto this dielectric layer 142. Each of the spectral filters is aligned with a photodetector located under the support layer 141. It is the upper dielectric layer 105 of the spectral filter that is in contact with the new dielectric layer 142.

Finally, if the support layer 203 used during the formation of the spectral filter is not transparent to the wavelength transmitted by the filter, this support layer 203, which is located at the top of the spectral filter, is etched in order to be eliminated.

1-27. (canceled)

28. A spectral filter comprising at least one metal layer structured by a grating of traversing slots, wherein the grating consists of at least two first subgratings of traversing slots intercepting one another perpendicularly.

29. The spectral filter according to claim 28, further comprising at least one third subgrating of traversing slots intercepting the slots of the two first subgratings.

30. The spectral filter according to claim 29, the slots of the third subgrating intercepting the slots of the two first subgratings at an angle equal to around 45 degrees.

31. The spectral filter according to claim 29, further comprising at least one fourth subgrating of traversing slots intercepting the slots of the two first subgratings and the slots of the third subgrating.

32. The spectral filter according to claim 31, the slots of the fourth subgrating perpendicularly intercepting the slots of the third subgrating.

33. The spectral filter according to claim 28, wherein the slots of one or each of the subgratings are regularly spaced apart and/or each comprise an identical width.

34. The spectral filter according to claim 28, each subgrating being formed by the repetition of a periodic pattern, said periodic pattern comprising one of the slots of the subgrating and a part of the metal layer separating two adjacent slots of the subgrating.

35. The spectral filter according to claim 34, wherein the width of the periodic pattern of one or each of the subgratings is less than around 350 nm.

36. The spectral filter according to claim 34, wherein the width of each of the slots of one or each of the subgratings is between around 10% and 50% of the width of the periodic pattern of this or these subgratings.

37. The spectral filter according to claim 28, wherein the thickness of the metal layer is between around 50 nm and several hundreds of nm

38. The spectral filter according to claim 28, wherein the metal layer is based on aluminium, and/or silver, and/or gold.

39. The spectral filter according to claim 28, wherein the space created by the slots in the metal layer is filled with a dielectric material.

40. The spectral filter according to claim 28, further comprising at least one first dielectric layer arranged above the structured metal layer and/or at least one second dielectric layer arranged below the structured metal layer.

41. The spectral filter according to claim 40, wherein the thickness of the first and/or the second dielectric layer is between around 50 nm and several hundreds of nm.

42. The spectral filter according to claim 39, wherein the dielectric has a refractive index less than around 1.6.

43. An image sensor comprising at least one first and one second spectral filter according to claim 28, arranged in a same horizontal plane, and at least two photodetectors arranged underneath the spectral filters.

44. The image sensor according to claim 43, wherein the filters are connected to each other.

45. The image sensor according to claim 43, wherein the thickness of the metal layer of the first spectral filter is different to the thickness of the metal layer of the second spectral filter.

46. The image sensor according to claim 43, wherein the thickness of the metal layer of the first spectral filter is identical to the thickness of the metal layer of the second spectral filter, and the width of the periodic pattern and/or the width of the slots of the two spectral filters is different.

47. The image sensor according to claim 43, further comprising a protective layer covering the spectral filters.

48. The image sensor according to claim 43, further comprising a third and a fourth spectral filter, the four spectral filters forming a Bayer filter, and at least two other photodetectors each arranged under one of the third and fourth spectral filters, the Bayer filter and the four photodetectors forming a pixel of the image sensor.

49. The image sensor according to claim 43, wherein the photodetectors are formed on a substrate.

50. The image sensor according to claim 43, further comprising a support layer arranged between the photodetectors and the spectral filters.

51. A method of producing a spectral filter, comprising the following steps:
forming a grating of slots in a dielectric layer, wherein the grating consists of at least two subgratings of slots intercepting one another perpendicularly,
depositing a metal layer in the grating of slots formed in the dielectric layer,
planarising the metal layer.

52. A method of producing a spectral filter, comprising the steps of:
depositing a metal layer on a dielectric layer,
impressing the metal layer forming, in the metal layer, a grating of slots, wherein the grating of slots consists of at least two subgratings of slots intercepting one another perpendicularly,
etching the metal layer at the level of the slots to make them traversing,
depositing a dielectric layer on the metal layer,
planarising said dielectric layer.

53. The method of producing a spectral filter according to claim 51, comprising after the planarisation step, a step of transferring the spectral filter onto another layer of dielectric through the intermediary of the dielectric layer of the spectral filter.

54. The method of producing a spectral filter according to claim 52, comprising after the planarisation step, a step of transferring the spectral filter onto another layer of dielectric through the intermediary of the dielectric layer of the spectral filter.

55. A method of producing an image sensor comprising, before the formation of at least one spectral filter according to claim 28, a step of depositing a support layer on at least one photodetector, wherein the spectral filter is formed on or transferred onto the support layer.
